(19) United States
(12) Patent Application Publication
(10) Pub. No.: US 2011/0126538 A1
(43) Pub. Date: Jun. 2, 2011

(54) POWER GENERATION APPARATUS

(75) Inventor: Ok Ju Kim, Jeollabuk-do (KR)

(73) Assignees: Ok Ju KIM, Gunsan-si, Jeollabuk-do (KR); Hye Jin JEONG, Iksan-si, Jeollabuk-do (KR); JINI CO., LTD., Jeonju-si, Jeollabuk-do (KR)

(21) Appl. No.: 13/057,156

(22) PCT Filed: Jul. 31, 2009
(86) PCT No.: PCT/KR2009/004273

§ 371 Date: Feb. 1, 2011

(30) Foreign Application Priority Data
Aug. 1, 2008 (KR) 10-2008-0075369
Jun. 23, 2009 (KR) 10-2009-0055998

(51) Int. Cl. F03G 3/00

(52) U.S. Cl. 60/639

(57) ABSTRACT

The power generation apparatus of the present invention provides a weight road that can move up and down; a moving storage tank guide box with a fluid storage part intended to collect fluid supplied from a fluid supply part provided at the top, a fluid discharge part provided at the bottom, and a supply opening and closing part provided at the bottom, and a supply opening and closing part intended to optionally discharge the fluid collected in the fluid storage part provided on the bottom of the fluid storage part; a moving storage tank with a recovery opening and closing part accommodated in the moving storage part guide box so that it can undergo up-and-down reciprocating motions between the fluid storage part and the fluid discharge part and that is intended to optionally discharge the collected fluid through the supply opening and closing part at a location adjacent to the fluid storage part to the fluid discharge part at a location adjacent to the fluid discharge part; and a power transmission unit that connects the moving storage tank with the weight load so as to enable power transmission so that the moving storage tank is moved downward when the weight load moves upward and the moving storage tank is moved upward when the weight load moves downward.

### TECHNICAL FIELD

The present invention relates to a power generation apparatus, and in particular to a power generation apparatus which can efficiently generate electric power even when a small amount of fluid is supplied from the outside.

### BACKGROUND ART

A power generation apparatus which is intended to use hydraulic power is basically directed to generating power when the fluid externally supplied from the outside directly collides with a turbine. The power generation apparatus which uses turbine needs fluid which should be supplied by as much amount as the fluid helps generate a power exceeding a friction force or an inertia force between mechanical elements. So, when the amount of fluid does is not exceeds a certain level, it is impossible to generate power.

In case of turbine, since an electric power is generated by means of an impact force generated when fluid collides with blades, energy loss increased in the course of collisions, which results in a lower power generation efficiency.

### DISCLOSURE OF INVENTION

Accordingly, it is an object of the present invention to provide a power generation apparatus which can keep generating power even when a small amount of fluid is supplied.

To achieve the above objects, there is provided a power generation apparatus, comprising a weight load which is movable upwards and downwards; a movable storage tank guide box which includes a storage part at its upper side for collecting fluid from a fluid supply part, a fluid discharge part provided at its lower side, and a supply opening and closing part for selectively discharging the fluid gathered at the fluid storage part; a movable storage part which is accommodated at the movable storage tank guide box and is movable upward and downwards between the fluid storage part and the fluid discharge part and includes a retrieval opening and closing part for selectively discharging the fluid collected via the supply opening and closing part at a portion close to the fluid storage part to the fluid discharge part at a portion close to the fluid discharge part; and a power transfer unit which connects the movable storage tank and the weight load in a way of transferring power and moves the movable storage tank downwards when the weight load moves upwards, and moves the movable storage tank upwards when the weight load moves downwards.

The power generation apparatus further comprises a weight load guide box in which the weight load is accommodated and is movable upwards and downwards; and a fluid transfer part which is provided at a lower side of either the weight load guide box or the movable storage tank guide box and is connected with the fluid discharge part in a way that fluid can flow and pressurizes the fluid inputted from the fluid discharge part with the aid of either the weight load or the self-weight of the movable storage tank and transfers the pressurized fluid to the fluid storage part via the transfer pipe.

The fluid transfer part is provided at a lower side of the weight load guide box and communicates with the fluid discharge part via the retrieval pipe so that the fluid of the fluid transfer part is pressurized by means of the self-weight of the weight load, and the fluid of the fluid discharge part can be inputted.

In addition, the power generation apparatus a supply opening and closing member which is provided at the movable storage tank so that the movable storage tank can allow the supply opening and closing part to open at a portion close to the fluid storage part; and a retrieval opening member which is provided at the fluid discharge part so that the movable storage tank can allow the retrieval opening and closing member to open at a portion close to the fluid discharge part, and the supply opening and closing part comprises a supply hole formed at the bottom of the fluid storage part; and a supply opening and closing part which is rotatably installed at the bottom of the fluid storage part for closing the supply hole with the aid of self-weight and rotates upwards with the aid of the supply opening member and allows the supply hole to open, and the retrieval opening and closing part comprises a retrieval hole formed at the bottom of the movable storage tank; and a retrieval opening member which is rotatably installed at the bottom of the movable storage tank for closing the retrieval hole with the aid of self-weight and rotates upwards with the aid of the retrieval opening member and allows the retrieval hole to open.

The fluid transfer part comprises a contractible member which includes an opening for inputting the fluid supplied from the retrieval pipe into the interior and becomes contractible by means of the weight load and transfers the fluid inputted into the interior via the opening to the fluid storage part via the transfer pipe; and a blocking member which is rotatably installed at the contractible member for selectively opening and closing the opening and moves depending on the movement of the weight load for thereby selectively opening and closing the opening.

The power generation apparatus further comprises a supply maintaining unit which limits the downward movements of the movable storage tank for the same to be maintained at a portion close to the fluid storing part until fluid is inputted from the fluid storage part into the movable storage tank by above a certain reference amount and releases the downward movement limit of the movable storage tank when the fluid is applied to the movable storage tank by above a certain reference amount; and a discharge maintaining unit which limits the upward movements of the movable storage tank for the fluid to keep discharging until fluid becomes below a certain reference level at a portion close to the fluid discharge part and releases the upward movement limit of the movable storage tank when the fluid of the movable storage tank becomes below a certain reference level.

The supply maintaining unit comprises a supply slide member which is slidable in upward and downward directions in the interior of the movable storage tank guide box; a supply slide spring which applies a tensional force for pulling the supply slide member upwards; a supply rotation member which is rotatably installed in upward and downward directions at an end portion of the supply slide member; a supply stopper which is slidable at the supply slide member in a radius direction of the movable storage tank guide box and selectively limits the operation that the supply rotation member rotates downwards; a supply stopper spring which pressurizes the supply stopper in a direction of the center of the movable storage tank guide box; a supply pullet which is provided at the other end portion of the supply slide member 271; and a supply wire of which one end is connected with the movable storage tank guide box, and the other end is fixed at the supply stopper 274 for thereby releasing the downward rotation limit of the supply rotation member by moving the supply stopper toward an outer surface of the movable storage tank guide box when the supply slide member moves downwards; and the discharge maintaining unit comprises a discharge slide member which is slidable in upward and downward directions in the interior of the movable storage tank guide box; a discharge slide spring which applies a tensional force to the discharge slide member so that the discharge slide member can be pulled upwards and pressurizes the slide member downwards when the discharge slide member moves upwards; a discharge rotation member which is rotatable in upward and downward directions at an end portion of the discharge slide member; a rotation return elastic member which returns the discharge rotation member to an original position in a state that the discharge rotation member has moved downwards; a discharge stopper which limits the discharge rotation member to rotate upwards; a discharge stopper spring which pressurizes the discharge stopper in the direction of the center of the movable storage tank guide box; a discharge pulley which is provided at the other end portion of the discharge slide member; and a discharge wire of which one end is fixed at the movable storage guide box in a way of surrounding part of the discharge slide member, and the other end portion is fixed at the discharge stopper for thereby obtaining an upward rotation of the discharge rotation member by moving the discharge stopper in an outer surface direction of the movable storage tank guide box when the discharge slide member moves upwards while overcoming the elastic force of the discharge slide spring.

According to an example of the present invention, the power transfer unit comprises at least one pulley; and a power transfer wire which surrounds at least part of the pulley and of which one end portion is fixed at the weight load, and the other end portion is fixed at the movable storage tank.

According to another example of the present invention, the power transfer unit comprises a first rack gear of which one end portion is fixed at the weight load; a second rack gear of which one end portion is fixed at the movable storage tank; and a plurality of power transfer gears which are engaged with the first and second rack gears, respectively, so that the weight load moves upwards when the movable storage tank moves downwards, and the weight load moves downwards when the movable storage tank moves upwards.

The retrieval pipe opening and closing unit is installed in the interior of the movable storage tank guide box and is movable in upward and downward directions and comprises an opening and closing member and includes an opening and closing member for selectively blocking the retrieval pipe depending on the upward and downward movements of the movable storage tank; and an elastic member which is provided at the opening and closing member and applies an elastic operation in a direction that the retrieval pipe opens.

There is further provided a buoyancy member which is provided at the bottom of the movable storage tank and moves upwards with the aid of the fluid gathered at the fluid discharge part as the retrieval pipe is blocked by means of the opening and closing member.

A spacer is provided at the bottom of the movable storage tank for allowing the fluid of the movable storage tank to input into the retrieval pipe via the retrieval opening and closing part by maintaining a certain space between the bottom of the movable storage tank and the bottom of the fluid discharge part.

There is provided a fluid transfer part of the power generation apparatus, which communicates with the fluid storage part via the transfer pipe and is provided at a lower side of the movable storage tank guide box and is connected with the fluid discharge part in a way of fluid transfer, wherein the fluid inputted from the fluid discharge part into the fluid transfer part is pressurized by means of the self-weight of the movable storage tank and is transferred to the fluid storage part via the transfer pipe.

The supply maintaining unit and the discharge maintaining unit can be electronically controlled, and there are provided a first fluid detection sensor which is downwardly protruded from the fluid storage part for thereby detecting the water level of the fluid filled in the movable storage tank; a second fluid detection sensor which is provided at the fluid discharge part for thereby detecting the water level of the fluid remaining in the movable storage tank; and a controller which controls the supply maintaining unit so that the downward movement of the movable storage tank is possible when the water level of the movable storage tank detected by the first fluid detection sensor is above a certain reference level, and controls the discharge maintaining unit so that the upward movement of the movable storage tank is possible when the water level of the movable storage tank detected by the second fluid detection sensor is below a certain reference value.

The power generation apparatus can be installed at sea, and in this case the fluid supply part becomes sea water. In this case, the fluid storage part may include an inlet part for inputting seawater with the aid of the water waves.

The inlet part comprises an inlet port provided at the fluid storage part for inputting water; and an opening and closing door for selectively opening and closing the inlet port depending on the amount of the water inputted into the fluid storage part.

When the power generation apparatus is installed at sea, the power generation apparatus comprises a forced discharge part for collecting the fluid inputted from the movable storage tank to the fluid discharge part; a water level detection sensor for detecting the water level of the forced discharge part; a pump for transferring the fluid of the forced discharge part to the outside when the water level of the forced discharge part detected by the water level detection sensor exceeds a certain reference value; and a check valve for preventing the water from reversely inputting into the forced discharge part.

To achieve the above objects, there is provided a power generation apparatus which comprises a weight load guide box; a weight load which is accommodated in the weight load guide box and is movable in upward and downward directions; a movable storage tank guide box which includes a fluid storage part at its upper side, a supply opening and closing part formed at the bottom of the fluid storage part for selectively discharging the fluid gathered at the fluid storage part, and a fluid discharge part formed at its lower side; a movable storage tank which is accommodated in the movable storage tank guide box so that it can reciprocate in upward and downward directions between the fluid storage part and the fluid discharge part, and includes a retrieval opening and closing part for selectively discharging the fluid gathered via the supply opening and closing part at a portion close to the fluid storage part toward the fluid discharge part at a portion close to the fluid discharge part; a power transfer unit which connects the movable storage tank and the weight load in a way of transferring power and moves the movable storage tank downwards when the weight load moves upwards, and moves the movable storage tank upwards when the weight load moves downwards; and a fluid transfer part which is provided at a lower side of the weight load guide box and communicates with the fluid storage part via the transfer pipe and communicates with the fluid discharge part via the retrieval pipe, wherein the fluid transfer part pressurizes the fluid inputted from the fluid discharge part via the retrieval pipe with the aid of the self-weight of the weight load and supplies to the fluid storage part via the transfer pipe.

### ADVANTAGEOUS EFFECTS

With the above troubleshooting means, it is possible to reliably generate power even when a small amount of fluid is supplied in such a manner that fluid is stored in a movable storage tank, the fluid stored in the fluid storage tank is moved to a movable storage tank.

Since the fluid transferred from a fluid transfer part to a fluid storage part is supplied along with the fluid of a fluid supply part, it is possible to generate power even when the amount of fluid in a fluid supply part is relatively smaller.

The fluid is collected at the fluid storage part by a certain amount, and then is supplied to the movable storage tank, so it is possible to enhance a down movement of the movable storage tank, which leads to enhancing power generation efficiency.

Since the fluid of the fluid transfer part is pressurized by a weight load or a self-weight of a movable storage tank and is supplied to the fluid storage part for thereby enhancing power generation efficiency.

A supply opening and closing part of a fluid storage part and a retrieval opening and closing part can be opened by using a supply opening member used so as to open a supply opening and closing part of a fluid storage part and a retrieval opening and closing member, so it is possible to enhance a power generation efficiency because an additional power is not used when controlling an opening and closing member.

Since a supply opening and close member of a supply opening and closing part and a retrieval opening and closing member of a retrieval opening and closing part close a supply hole and a retrieval hole, respectively, with the aid of self-weights, it is possible to minimize the power to be used for controlling the power generation apparatus.

A fluid transfer part consists of an extendable member and a blockage member, by which it is possible to minimize a friction force between a weight load used for pressurizing the fluid transfer part and a weight load guide box, which leads to enhancing power generation efficiency.

The weight load can be for a movable storage tank to move up and down by means of a supply maintaining unit and a discharge maintaining unit, and a up and down motion of a movable storage tank can be enhanced by the same. A higher power can be transferred to the outside with the aid of enhanced up and down motions of the movable storage tank, and a higher power (corresponding to energy which can be generated per unit hour) can be produced.

Since a power transfer unit is made of a rack gear and a plurality of power transfer gears, an up motion generated by means of a movable storage tank can be converted into an up motion power. The fluid can gather at a fluid discharge part by blocking a retrieval pipe when the movable storage tank is positioned close to the fluid discharge part, and the movable storage tank can move up by means of a buoyancy of the gathered fluid, which leads to maximizing the efficiency of power generation.

The movable storage tank and the fluid discharge part are made spaced apart by installing a spacer member at the fluid discharge part for thereby efficiently discharging fluid from the movable storage tank.

### BRIEF DESCRIPTION OF THE DRAWINGS

The present invention will become better understood with reference to the accompanying drawings which are given only by way of illustration and thus are not limitative of the present invention, wherein;

FIGS. 1 to 8 are various schematic views of a power generation apparatuses according to a first embodiment of the present invention, while describing a power generation procedure;

FIG. 9 is a schematic view illustrating a power generation apparatus according a second embodiment of the present invention;

FIG. 10 is a schematic perspective view illustrating a fluid transfer part of FIG. 9;

FIGS. 11 to 15 are schematic views illustrating a supply maintaining unit of FIG. 9, while describing an operation of a supply maintaining unit;

FIGS. 16 to 20 are schematic views illustrating a discharge maintaining unit of FIG. 9, while describing an operation of a discharge maintaining unit;

FIG. 21 is a schematic view illustrating a driving force transfer unit of a power generation apparatus according to a third embodiment of the present invention;

FIG. 22 is a schematic view illustrating a retrieval opening and closing unit of a driving force generation apparatus according to a third embodiment of the present invention;

FIG. 23 is a schematic view illustrating a power generation apparatus according to a fourth embodiment of the present invention;

FIG. 24 is a schematic view illustrating a power generation apparatus according to a fifth embodiment of the present invention;

FIGS. 25 to 27 are schematic views illustrating a power generation apparatus according to a sixth embodiment of the present invention, while describing a moving operation of a movable storage tank;

FIGS. 28 to 30 are views for describing an operation of a supply maintaining unit of FIG. 25;

FIGS. 31 to 33 are views for describing an operation of a discharge maintaining unit of FIG. 25;

FIG. 34 is a block diagram illustrating a control operation of a supply maintaining unit and a discharge maintaining unit of FIG. 25;

FIG. 35 is a schematic view illustrating a power generation apparatus according to a seventh embodiment of the present invention;

FIGS. 36 to 38 are views for describing an operation of an inlet part of FIG. 35;

FIG. 39 is a schematic view illustrating a power generation apparatus according to an eighth embodiment of the present invention; and

FIG. 40 is a schematic view illustrating a power generation apparatus according to a ninth embodiment of the present invention.

### MODES FOR CARRYING OUT THE INVENTION

The power generation apparatus according to the preferred embodiments of the present invention will be described.

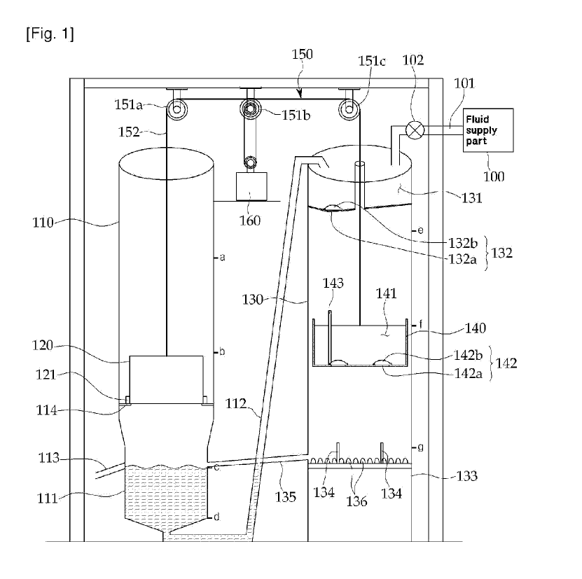

As shown in FIG. 1, the power generation apparatus according to a first embodiment of the present invention comprises a weight load guide box 110, a weight load 120 which is movable up and down in the interior of the weight load guide box 110, a movable storage tank guide box 130 disposed close to the weight load guide box 110, a movable storage tank 140 which is movable in up and down directions in the interior of the movable storage tank guide box 130, and a power transfer unit 150 which drivingly connects the weight load 120 and the movable storage tank 140.

The weight load guide box 110 guides the up and down movements of the weight load 120. A fluid transfer part 111 is provided at a lower side of the weight load transfer guide box 110, and the fluid transfer part 111 is connected with the movable storage tank guide box 130 via a transfer pipe 112 and is connected with a fluid discharge part 133 of a lower side of the movable storage tank guide box 130 via a retrieval pipe 135. The fluid transfer part 111 is to supply the fluid received from the fluid discharge part 133 via the retrieval pipe 135 to the fluid storage part 131, and the fluid of the fluid transfer part 111 is pressurized by means of the self-weight of the weight load 120 and is supplied to the fluid storage part 131 via the transfer pipe 112.

The weight load 120 is used to help cause a seesaw motion along with the movable storage tank 140 and is heavier than the movable storage tank 140 when fluid is not in the movable storage tank 140, and is lighter than the movable storage tank 140 when a certain amount of fluid is filled in the movable storage tank 140. So, the weight load 120 and the movable storage tank 140 moves like a seesaw motion depending on the weight of the fluid in the movable storage tank 140.

A sealing protrusion part 121 is provided at an outer surface of the weight load 120 for transferring the fluid of the fluid transfer part 111 to the fluid storage part 131 of the movable storage tank guide box 130 via the transfer pipe 112. The fluid transfer part 111 has a diameter smaller than the diameter of the weight load guide box 110, so the sealing protrusion part 121 can do like a piston movement. The diameter except for the fluid transfer part 111 of the weight load guide box 110 is larger than the sealing protrusion part 121, which makes it possible to minimize the loss of energy due to a friction force in the course of up and down motions of the weight load 120, by which it is possible to increase a pressurizing force to be used for transferring the fluid in the fluid transfer part 111, and it is possible to increase the amount of fluid which is to be transferred from the fluid transfer part 111 to the fluid storage part 131. In addition, a sealing protrusion part 121 is formed at an outer surface of the weight load 131. It is possible to maximize the application of the position energy of the weight load 120 by pressurizing the fluid of the fluid transfer part 111 while maintaining a sealed state with the inner wall of the fluid transfer part 111.

An initial position maintaining part 114 is formed at an inner wall of the weight load guide box 110 for the weight load 120 to be positioned at an initial position. The initial position maintaining part 114 is used to support the weight load 120 under the circumference that the power generation apparatus is not driven. When the power generation apparatus starts operating, a person can manually release the initial position maintaining part 114 by rotating an externally installed lever as well as can automatically release the initial position maintaining part 114 by transferring a signal by a switch or something to a motor driving or a driving cylinder or a solenoid driving part.

The movable storage tank guide box 130 is to guide an up and down movement of the movable storage tank 140 and includes a fluid storage part 131 at its upper portion for gathering a certain amount of fluid and supplying to the movable storage tank 140, and a fluid discharge part 133 at its lower portion for discharging the fluid stored in the movable storage tank 140.

The fluid storage part 131 is provided at an upper side of the movable storage tank guide box 130 for gathering a certain amount of the fluid and supplying to the movable storage tank 140. Fluid from the fluid transfer part 111 and the fluid from an external fluid supply 100 are gathered in the fluid storage part 131. As the fluid of the fluid transfer part 111 is supplied to the fluid storage part 131, it is possible to reduce the amount of fluid supplied from the external fluid supply part 100, which means that it is possible to generate power with the external fluid supply part 100 with a small amount of fluid supply.

The fluid supply part 100 might be formed of a storage tank for storing underwater via pumping, a storage tank generally installed at an apartment building or a high rise place or a storage tank for receiving water from a river, a dam or a valley and storing the same. The supply pipe 101 for supplying the fluid of the fluid supply part 100 to the fluid storage part 131 is equipped with a stop valve 102. The stop valve 102 can be manually closed or opened or can operate in response to an electric signal. When the stop valve 102 is designed to operate in response to an electric signal, a water level detection sensor (not shown) is installed at the fluid storage part 131 for thereby automatically controlling the stop valve 102 depending on the amount of fluid stored in the fluid storage part 131 detected by means of the water level detection sensor (not shown). Namely, when the water level of the fluid stored in the fluid storage part 131 is below a first reference amount, the stop 102 is opened for thereby supplying the fluid of the fluid supply part 100 to the fluid storage part 131, and when the water level of the fluid stored in the fluid storage part 131 is above a second reference amount, the stop valve 102 is closed for thereby stopping the supply of the fluid of the fluid supply part 100 to the fluid storage part 131, which can be automatically controlled.

A supply opening and closing part 132 is prepared at the bottom of the fluid storage part 131 for supplying stored fluid to the movable storage tank 140. The supply opening and closing part 132 comprises a supply hole 132a formed at the bottom of the fluid storage part 131 and a supply opening and closing member 132b for selectively opening and closing the supply hole 132a. Here, the supply opening and closing member 132b is rotatably installed at the bottom of the fluid storage part 131. The movable storage tank 140 moves upward and rotate in an upward direction while being pushed by the supply opening and closing member 143 provided at the movable storage tank 140 for thereby opening the supply hole 132a, and when the movable storage tank 140 moves downward, it rotates downwards by its self-weight for thereby closing the supply hole 132a. When the movable storage tank 140 moves downward, and the supply opening member 143 is spaced apart from the supply opening and closing member 132b, the supply opening and closing member 132b does not directly close the supply hole 132a because the supply opening and closing member 132b remains floated by means of the buoyancy of the fluid in the fluid storage part 131. Therefore, even when the movable storage tank 140 moves downwards, and the supply opening member 143 is spaced apart from the supply opening and closing member 132b, the fluid of the fluid storage part 131 drops free while keeping supplying to the movable storage tank 140.

The bottom of the fluid storage part 131 is inclined toward the supply hole 132a so as to efficiently use the fluid by making the fluid supplied to the fluid storage part 131 more efficiently flow via the supply hole 132a.

The fluid discharge part 133 is provided at a lower side of the movable storage tank guide box 130 for thereby discharging the fluid gathered at the movable storage tank 140 and transferring the discharged fluid to the fluid transfer part 111 while communicating with the fluid transfer part 111 and the retrieval pipe 135, respectively. A spacer member 136 is provided at the bottom of the fluid discharge part 133 for making the discharge of the movable storage tank 140 easier by spacing the movable storage tank 140 and the bottom of the fluid discharge part 133. At the fluid discharge part 133 is provided a retrieval opening member 134 for opening the retrieval opening and closing part 142 of the movable storage tank 140.

The movable storage tank 140 has a weigh changing depending on the amount of the collected fluid for thereby performing a seesaw motion with the aid of the weight load 120 and the power transfer unit 150. At the movable storage tank 140 is installed an accommodation part 141 for gathering fluid, and at the bottom of the accommodation part 141 is provided a retrieval opening and closing part 142 for selectively discharging the fluid gathered at the accommodation part 141. At the movable storage tank 140 is provided a supply opening member 143 for selectively opening and closing the supply opening and closing member 132b.

The retrieval opening and closing part 142 comprises a retrieval hole 142a formed at the bottom of the accommodation part 141, and a retrieval opening and closing member 142b which is rotatably installed at the bottom of the accommodation part 141 for selectively opening and closing the retrieval hole 142a. The retrieval opening and closing member 142b is pulled by the retrieval opening member 134 for thereby opening the retrieval hole 142a, and when the movable storage tank 140 moves upward, and the retrieval opening member 134 is spaced apart from the retrieval opening and closing member 142b, the retrieval opening and closing member 142b rotates downwards with the aid of self-weight for thereby opening the retrieval hole 142a.

The power transfer unit 150 is provided so as to connect the weight load 120 and the movable storage tank 140 for transferring power between the same and comprises a plurality of pulleys 151a, 151b and 151c and a power transfer wire 152 of which one end is connected with the weight load 120, and the other end is connected with the movable storage tank 140. With the above construction, when the weight load 120 is heavier than the movable storage tank 140, the weight load 120 moves downwards, whereas the movable storage tank 140 moves upwards. When the fluid is filled in the accommodation part 141 of the movable storage tank 140, and the movable storage tank 140 is heavier than the weight load 120, the movable storage tank 140 moves downwards, and the weight load 120 moves upwards.

The puller 151b is connected with a power conversion apparatus 160 for converting the kinetic energy of the power transfer wire 152 into electric energy. The power conversion apparatus might comprise an electric generator or something for generating electric energy.

The operation of the power generation apparatus having the above elements will be described.

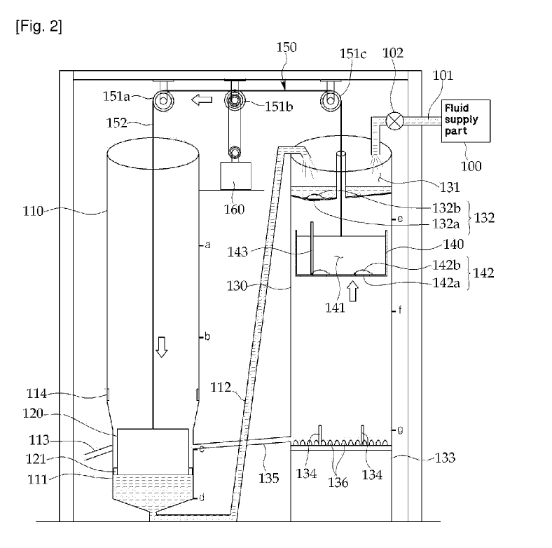

As shown in FIG. 1, when the power generation apparatus is not intended to operate, the weight load 120 is fixed in the interior of the weight load guide box 110 by means of the initial position maintaining part 114, and the accommodation part 141 of the movable storage tank 140 remains empty. In the above state, as shown in FIG. 2, when the initial position maintaining part 114 is released by a manual or automatic way, the weight load 120 moves downwards because it is heavier than the movable storage tank 140, and the movable storage tank 140 moves upwards by means of the power transfer wire 152. When the weight load 120 moves downwards and pressurizes the fluid gathered at the fluid transfer part 111, the fluid of the fluid transfer part 111 moves upwards via the transfer pipe 112 and is supplied to the fluid storage part 131. The cross sectional area of the fluid transfer part 111 is much larger than the cross sectional area of the transfer pipe 112, the surface level of the fluid of the transfer pipe 112 might be formed at a much higher position than the surface level of the fluid of the fluid transfer part 111 which is pressurized by means of the weight load 120 based on Pascal's principle, and the fluid of the transfer pipe 112 flows via the upper side of the transfer pipe 112 and is supplied to the fluid storage part 131.

As shown in FIG. 2, the stop valve 102 is opened manually or in accordance with an external electric signal, so the fluid of the fluid supply part 100 is stored in the fluid storage part 131.

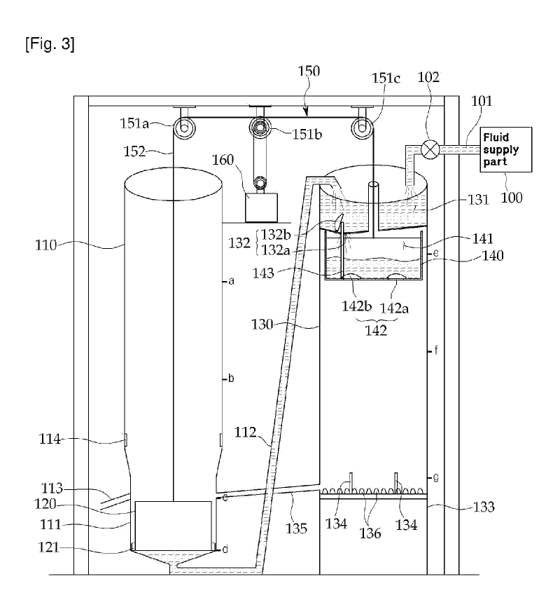

As shown in FIG. 3, when the weight load 120 continues to move downwards and stops by the housing of the fluid transfer part 111, and the movable storage tank 140 keeps moving upwards, and the supply opening member 143 of the movable storage tank 140 pushes upwards the supply opening and closing member 132b for thereby opening the supply hole 132a. The fluid stored in the fluid storage part 131 is gathered at the movable storage tank 140 via the supply hold 132a.

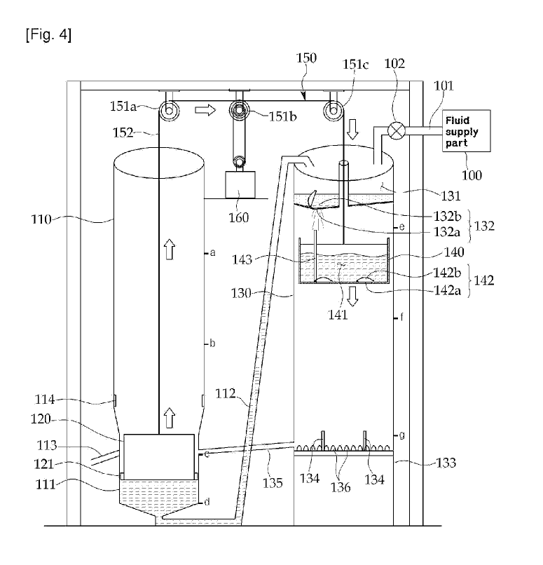

As shown in FIG. 4, when a certain amount of fluid is supplied to the movable storage tank 140 and the weight of the movable storage tank 140 becomes heavier than the weight load 120, the movable storage tank 140 starts getting moved downwards. Even when the movable storage tank 140 starts getting moved, the supply opening and closing member 132b keeps the supply hole 132a opened by means of the buoyancy of the fluid gathered at the fluid storage part 131, by which the movable storage tank 140 keeps receiving the fluid from the fluid storage tank 131 while moving downwards. The downward moving speed of the movable storage tank 140 is getting increased more and more, and the acceleration of the movable storage tank 140 is getting increased more and more.

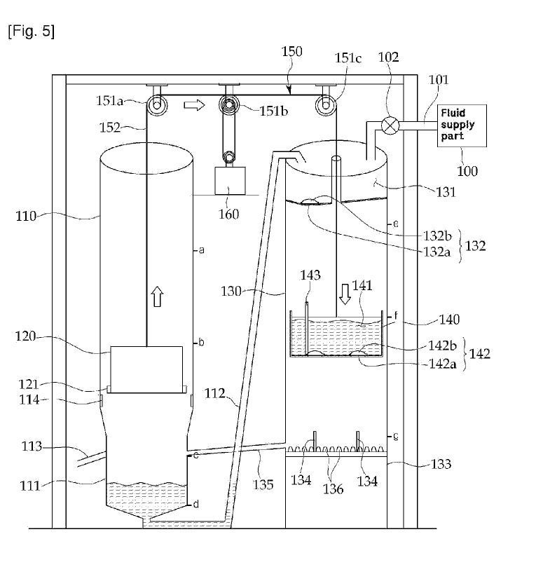

As shown in FIG. 5, when all of the fluid of the fluid storage part 131 is discharged toward the accommodation part 141 of the movable storage tank 140, the supply opening and closing member 132b of the fluid storage part 131 rotates downwards for thereby blocking the supply hole 132a. At this time, the stop valve 102 is opened, and the fluid of the fluid supply part 100 is supplied to the fluid storage part 131.

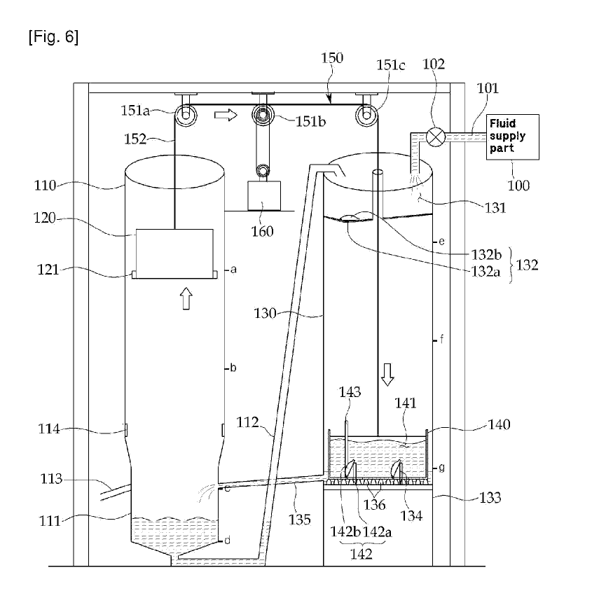

As shown in FIG. 6, when the movable storage tank 140 keeps moving downwards and approaches close to the bottom of the fluid discharge part 133, the retrieval opening member 134 of the fluid discharge part 133 pushes upwards the retrieval opening and closing member 142b for hereby opening the retrieval hole 142a. The fluid gathered at the accommodation part 141 of the movable storage tank 140 is drained toward the fluid discharge part 133, and the drained fluid is filled again into the fluid transfer part 111 via the retrieval pipe 135.

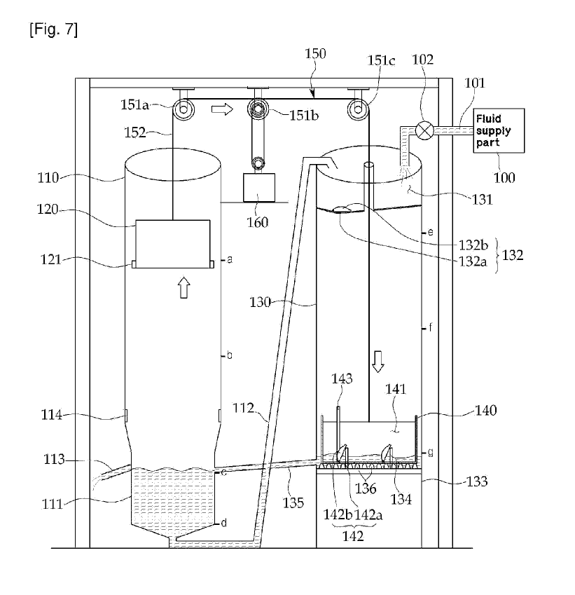

As shown in FIG. 7, when the amount of the fluid remaining in the accommodation part 141 of the movable storage tank 140 is below a certain reference level, the movable storage tank 140 becomes lighter than the weight load 120. At this moment, the movable storage tank 140 starts moving upwards again with the aid of the downward motion of the weight load 120. When the fluid discharged toward the fluid transfer part 111 via the retrieval pipe 135 exceeds a certain amount, it discharges to the outside via the retrieval pipe 113.

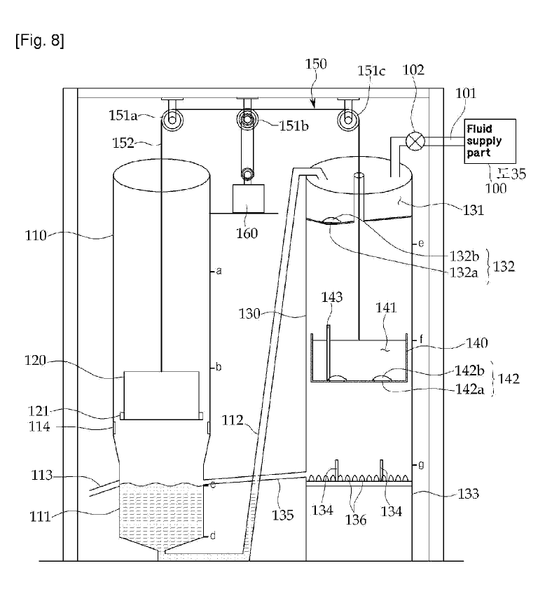

As shown in FIG. 8, when the movable storage tank 140 moves upwards, the retrieval opening member 134 becomes spaced apart from the retrieval opening and closing member 142b, but the retrieval opening and closing member 142b does not fully close the retrieval hole 142a due to the buoyancy of the fluid remaining in the movable storage tank 140. Namely, the retrieval opening and closing member 142b fully closes the retrieval hole 142a after the fluid of the movable storage tank 140 is all discharged toward the fluid discharge part 133, after which the routines 2 to 7 are repeatedly performed.

The fluid stored in the fluid storage part 111 is supplied to the fluid storage part 131 in addition to the fluid supplied from the external fluid supply part 100 for thereby generating power even when the amount of the fluid from the fluid supply part 100 is small.

In the above embodiment of the present invention, the occasion that the fluid of the fluid transfer part 111 is transferred to the fluid storage part 131 with the aid of the weight load 120, but when the amount of the fluid by the weight load 120 is less or when it is needed to reduce the supply time of the fluid, it is possible to forcibly transfer the fluid of the fluid transfer part 111 to the fluid storage part 131 by using a pump or something.

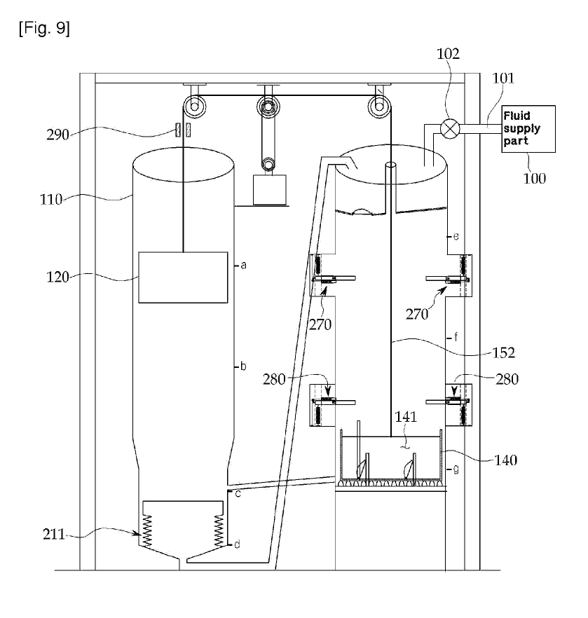

FIGS. 9 to 20 are schematic views of a power generation apparatus according to a second embodiment of the present invention.

As shown in FIG. 9, the power generation apparatus according to a second embodiment of the present invention, as compared to the first embodiment of the present invention, the structure of the fluid transfer part 211 has been changed, and the supply maintaining unit 270 and the discharge maintaining unit 280 are further added, and the brake apparatus 290 is further added to limit the movement of a supply maintaining wire 152. Since the structures and operations are same as the first embodiment except for the above mentioned differences, only the different matters will be described. In the following descriptions, while the second embodiment is described, the same elements as the first embodiment will be given the same reference numerals in the second embodiment of the present invention.

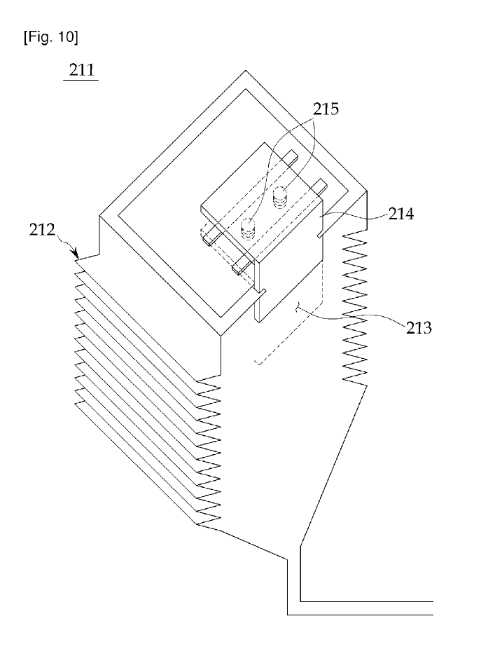

As shown in FIGS. 9 and 10, the fluid transfer part 211 comprises a contractible member 212, a blocking member 214 and an elastic member 215.

The contractible member 212 is contracted with the aid of the self-weight of the weight load 120 when the weight load 120 moves downwards and returns to its original position with the aid of its self-elastic force. At one side of the contractible member 212 is provided an opening 213 for introducing fluid.

The blocking member 214 blocks the opening 213 so that the interior of the contractible member 212 keeps sealed state when the contractible member 212 is contracted. The blocking member 214 slides along the contractible member 212 for selectively blocking the opening 213.

The elastic member 215 is provided to return the blocking member 214 to its original position. When it is pressed by the weight load 120 after blocking the opening 213, and the weight load 120 moves upwards, the blocking member 214 moves upwards so as to open the opening 213 with the aid of the elastic force of the elastic member 215. As shown in FIG. 10, the elastic member 215 is disposed between the contractible member 212 and the blocking member 214.

The operation of the fluid transfer part 211 having the above construction will be described. As shown in FIG. 10, in a state that the weight load 120 is spaced apart from the contractible member 212, the contractible member 212 becomes an extended state, and the opening 213 remains open. So, the fluid supplied via the retrieval pipe 135 can be inputted into the interior of the contractible member 212 via the opening 213.

In the above state, when the weight load 120 moves downwards, the weight load 120 presses the blocking member 213. When the elastic member 215 is compressed, the blocking member 214 moves downwards and blocks the opening 213. The weight load 120 keeps moving downwards, and the weight load 120 pressurizes the contractible member 212 for thereby contracting the same. The fluid in the contractible member 212 is compressed and transferred to the fluid storage part 131 via the transfer pipe 112. When the weight load 120 moves upwards, the contractible member 212 is extended with the aid of its self-elastic force and returns to the state as shown in FIG. 10. The blocking member 214 moves upwards with the aid of the elastic force of the elastic member 215 for thereby opening the opening 213.

Since the contractible member 212 is used for the fluid transfer part 211, the weight load 120 does not contact with the inner wall of the fluid transfer part 211 of the weight load guide box 110, and the power loss can be prevented due to the friction of the same for thereby enhancing the efficiency of the power generation apparatus.

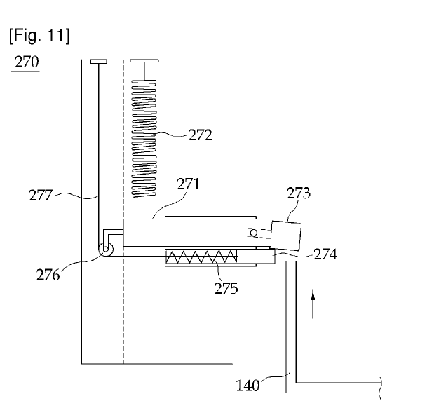

As shown in FIGS. 11 to 15, the supply maintaining unit 270 is provided so as to limit the downward movement timing of the movable storage tank 140 and is installed at an inner surface of the movable storage tank guide box 130. In more particular, the supply maintaining unit 270 comprises a supply slide member 271 which slides in up and down directions in the interior of the movable storage tank guide box 130, a supply slide spring 272 which provides a tensional force so that the supply slide member 271 can be upwardly pulled, a supply rotation member 273 which is rotatably installed at an end of the supply slide member 271, a supply stopper 274 which limits a downward rotation of the supply rotation member 273, a supply stopper spring 275 which pressurizes the supply stopper 274 toward the outside, a supply pulley 276 which is provided at the other end of the supply slide member 271, and a supply wire 277 of which one end is fixed at the movable storage tank guide box 130, and the other end is fixed at the supply stopper 274.

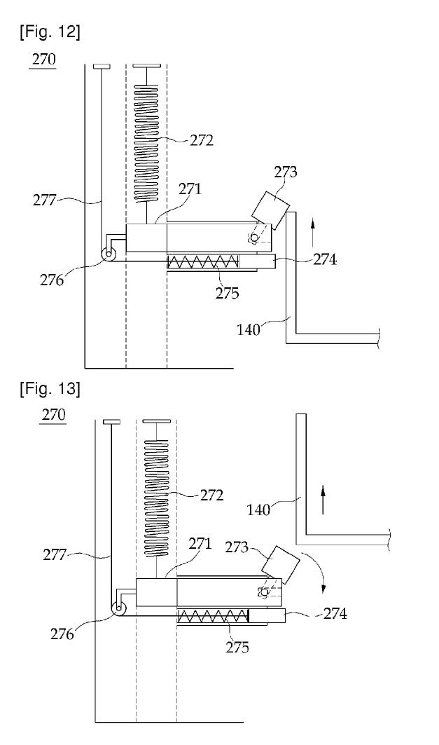

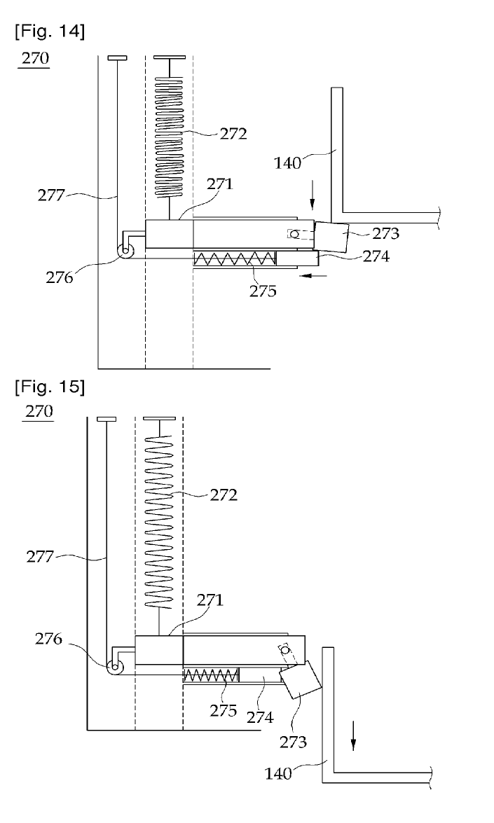

The operation of the supply maintaining unit 270 will be described. As shown in FIG. 11, in a state that the movable storage 140 does not contact with the supply rotation member 273 while being moving upwards, as shown in FIG. 12, when the movable storage tank 140 moves upwards and pushes upwards the supply rotation member 273, the supply rotation member 273 rotates upwards, and as shown in FIG. 13, the movable storage tank 140 passes over the supply maintaining unit 270. When the upward movement of the movable storage tank 140 is finished, the supply rotation member 273, as shown in FIG. 14, returns to its original position by means of a self-weight. The fluid of the fluid storage part 131 is gathered into the accommodation part 141 of the movable storage tank 140. When the movable storage tank 140 becomes heavier than the weight load 120, the movable storage tank 140 starts moving downwards and comes into contact with the supply rotation member 273 and is supported. At this time, the downward rotation of the supply rotation member 273 is limited by means of the supply stopper 274. So, the supply rotation member 273 limits the downward movement of the movable storage tank 140.

In the above state, the fluid of the fluid storage part 131 is supplied to the movable storage tank 140, and the weight of the movable storage tank 140 is getting increased more and more. When the weight of the movable storage tank 140 exceeds the elastic force of the supply slide spring 272, the supply slide spring 272 starts extending, and the supply slide member 271 starts moving downwards. At this time, one end of the supply wire 277 is fixed at the movable storage tank guide box 130, so the supply wire 277 keeps pulling the supply stopper 274 in an inward direction. So, the supply stopper 274 moves inwards, and the supply rotation member 273 starts rotating downwards. When the supply rotation member 273 rotates downwards, the movable storage tank 140 starts moving downwards.

The downward movement of the movable storage tank 140 is limited by means of the supply rotation member 273 until the weight of the same becomes larger than the elastic force of the supply slide spring 272 and starts downward moving after the fluid is filled in the movable storage tank 140 more than a certain reference amount. So, it is possible to increase the down movement speed of the movable storage tank 140, which results in enhancing power generation efficiency.

The discharge maintaining unit 280 discharges the fluid until the fluid of the movable storage tank 140 remains below a certain reference level and allows the movable storage tank 140 to move upwards for thereby enhancing the upward movement speed of the movable storage tank 140. The discharge maintaining unit 280 is has a similar structure with the supply maintaining unit 270.

In more details, the discharge maintaining unit 280 comprises a discharge slide member 281 which slides in upward and downward directions in the interior of the movable storage tank guide box 130, a discharge slide spring 282 which applies a tensional force for upwardly pulling the discharge slide member 281, a discharge rotation member 283 which is rotatably installed at an end portion of the discharge slide member 281, a rotation return elastic member 284 which returns the discharge rotation member 283 to its original position, a discharge stopper 285 which limits the upward rotation of the discharge rotation member 283, a discharge stopper spring 286 which pressurizes the discharge stopper 285 toward the outside, a discharge pulley 287 which is provided at the other end portion of the discharge slide member 281, and a discharge wire 288 of which one end is fixed at the movable storage tank guide box 130, and the other end portion is fixed at the discharge stopper 285.

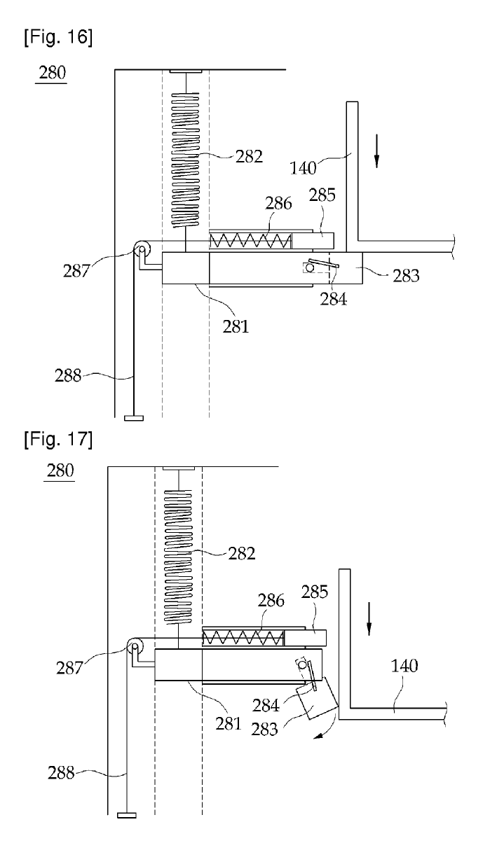

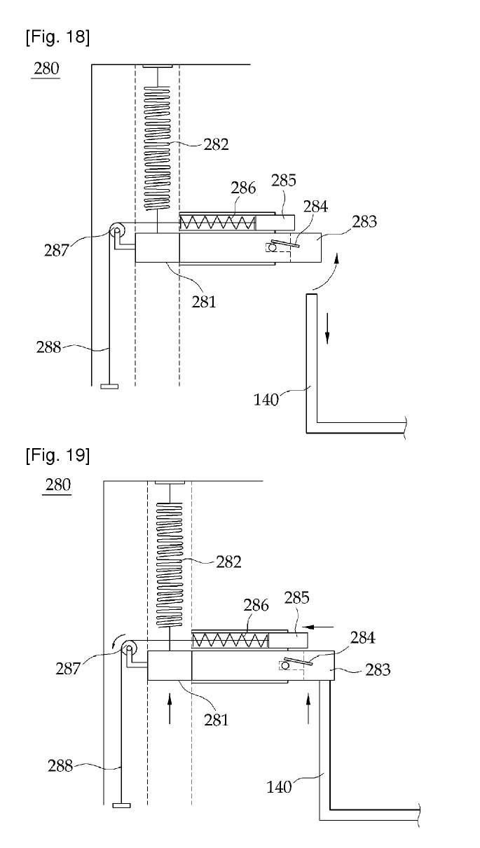

The operation of the discharge maintaining unit 280 will be described. As shown in FIG. 16, when the movable storage tank 140 moves downwards and comes into contact with the discharge rotation member 283 and pressurizes the same in the downward direction, as shown in FIG. 17, the discharge rotation member 283 rotates downwards overcoming the elastic force of the rotation return elastic member 284. As shown in FIG. 18, the movable storage tank 140 passes through the discharge maintaining unit 280 and moves downwards. The discharge rotation member 283 returns to its original position with the aid of the rotation return elastic member 284 after it passes through the discharge maintaining unit 280.

The fluid of the movable storage tank 140 starts discharging toward the fluid discharge part 133. When the fluid of the movable storage tank 140 discharges by a certain amount, and the weight of the movable storage tank 140 becomes lighter than the weight load 120, the movable storage tank 140 moves upwards again. As shown in FIG. 19, when the upward movement of the movable storage tank 140 is limited by means of the discharge rotation member 283 of which upward rotation has been limited by means of the discharge stopper 285. So, the movable storage tank 140 keeps discharging fluid toward the fluid discharge part 133 while coming into contact with the discharge rotation member 283. A difference of the weights of the movable storage tank 140 and the weight load 120 increases, so the force allows the movable storage tank 140 to move upwards increases.

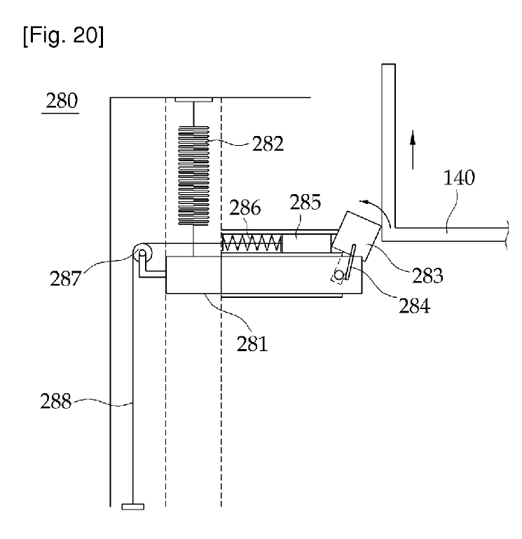

When the upward movement force of the movable storage tank 140 increases and exceeds the elastic force of the discharge slide spring 282, as shown in FIG. 19, the discharge slide member 281 slides upwards while compressing the discharge slide spring 282. At this time, one end of the discharge wire 288 is fixed at the movable storage tank guide box 130, so the discharge wire 288 pulls the discharge stopper 285, and as shown in FIG. 20, the discharge rotation member 283 becomes a state that it can rotate upwards. So, the movable storage tank 140 can push the discharge rotation member 283.

The discharge stopper 285 returns to its original position with the aid of the elastic force of the discharge stopper spring 286 and returns to the state of FIG. 16, and the discharge rotation member 283 returns to its original position by means of the self-weight and the rotation return elastic member 284, respectively.

The upward movement of the movable storage tank 140 can be limited until the weight of the fluid remaining in the accommodation part 141 becomes a certain level, and at the time when a difference between the weights of the movable storage tank 140 and the weight load 120 is large at the rising time of the movable storage tank 140, the rising speed of the movable storage tank 140 is enhanced, which leads to enhancing power generation efficiency.

In the present embodiment of the present invention, the example that the supply maintaining unit 270 and the discharge maintaining unit 280 have operated mechanically, but the supply maintaining unit 270 and the discharge maintaining unit 280 might be electrically operated by detecting a water level of the movable storage tank 140.

The brake apparatus 290 limits the movement of the power transfer wire 152 while preventing the movable storage tank 140 and the weight load 120 from falling down and might be formed of various brake apparatuses such as hydraulic or pneumatic brake systems, an electric brake system or something.

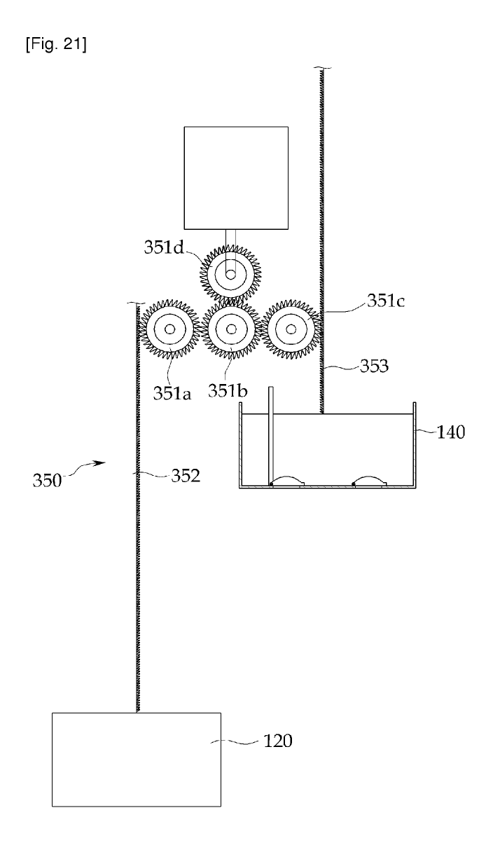

FIGS. 21 and 22 are schematic views of the major elements of the power generation apparatus according to a third embodiment of the present invention.

As shown in FIG. 21, the power generation unit 350 of the power generation apparatus according to a third embodiment of the present invention comprises a plurality of power transfer gears 351a, 351b, 351c and 351d, and first and second rack gears 352 and 353, which are different from the first and second embodiments of the present invention.

The lower side of the first rack gear 352 is fixed to the weight load 120, and the lower side of the second rack gear 353 is fixed to the movable storage tank 140. The first and second rack gears 352 and 353 are engaged with the power transfer gears 351a, 351b, 351c respectively. The numbers of the power transfer gears 351a, 351b, 351c are determined in such a manner that the first and second rack gears 352 and 353 are to move in opposite directions from each other. Namely, an odd number of the power transfer gears 351a, 351b and 351c should be used.

It is possible to generate power by a rising force of the movable storage tank 140 differently from the power transfer wire 152 by connecting the weight load 120 and the movable storage tank 140 by using a plurality of gears. In the present embodiment, the movable storage tank 140 can rise with the aid of the rising force by the buoyancy at the fluid discharge part 133 in addition to the rising force by means of the self-weight of the weight load 120.

As shown in FIG. 22, a buoyancy member 370 is attached to the bottom of the movable storage tank 140. A retrieval pipe opening and closing unit 354 is provided at a lower side of the movable storage tank guide box 130 for selectively opening and closing the retrieval pipe 135 in cooperation with the up and down movements of the movable storage tank 140.

The retrieval pipe opening and closing unit 354 comprises an opening and closing member 356 which is movable in up and down directions in the interior of the movable storage tank guide box 130, and an elastic member 355 of which one end portion is fixed at the movable storage tank guide box 130 for applying an elastic tensional force to the opening and closing member 356, and the other end portion is fixed to the opening and closing member 356.

The opening and closing member 356 comprises a sync operation part 356a for selectively coming into pressurized contact depending on the up and down movements of the movable storage tank 140, and the blocking part 356b comprises a blocking part 356b for selectively blocking.

The operation of the retrieval pipe opening and closing unit 354 with the above construction will be described. First of all, when the movable storage tank 140 moves downwards and comes into contact with the sync operation part 356a for thereby pressurizing the sync operation part 356a in a downward direction. The opening and closing member 356 moves downwards, and the blocking member 356b blocks the retrieval pipe 135. In the above state, the retrieval hole 142a of the movable storage tank 140 becomes open, and the fluid of the movable storage tank 140 is discharged to the fluid discharge part 133. At this time, since the retrieval pipe 135 is blocked, the discharging fluid is gathered at the fluid discharge part 133. The gathered fluid operates providing a buoyancy to the buoyancy member 370 of the movable storage tank 140 for thereby moving upwards the movable storage tank 140. The movable storage tank 140 rises with the aid of the rising force of the weight load 120 and the rising force of the buoyancy for thereby generating a relatively larger power via the second rack gear 353, which results in enhancing the power generation efficiency.

When the movable storage tank 356 rises, the opening and closing member 356 returns to its original position by means of an elastic force of the elastic member 355, and the fluid of the fluid discharge part 133 is transferred to the fluid transfer part 111 via the retrieval pipe 135.

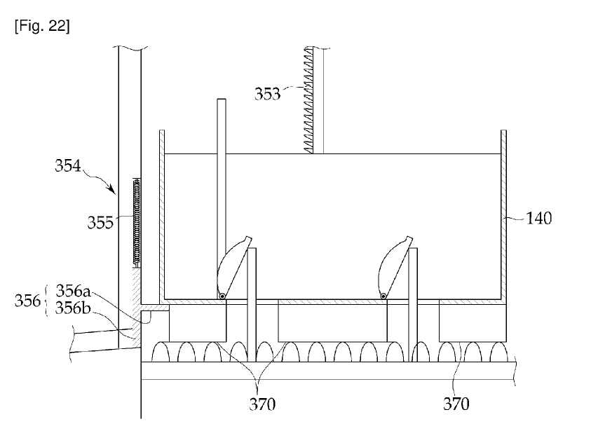

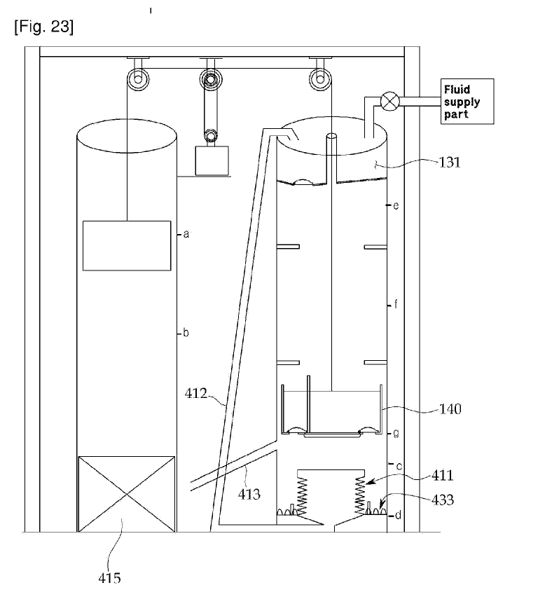

FIG. 23 is a schematic view illustrating the power generation apparatus according to a fourth embodiment of the present invention. In the fourth embodiment of the present invention differently from the second embodiment, the fluid transfer part 411 is formed at a lower side of the movable storage tank guide box 130, and the drain pipe 413 is connected with the movable storage tank guide box 130. The retrieval pipe 135 of the second embodiment of the present invention is removed. The transfer pipe 411 is connected with the fluid storing part 131 from the fluid transfer part 411, and the fluid of the fluid transfer part 411 pressurized by means of the movable storage tank 140 is transferred to the fluid storage part 131.

At the bottom of the weight load guide box 110 is provided an impact releasing member 415 for preventing any impact by means of the weight load 120.

The fluid discharged from the movable storage tank 140 to the fluid discharge part 433 by means of the weight of the movable storage tank 140 is transferred to the fluid transfer part 411. The other operations are same as the second embodiment, so the detailed descriptions will be omitted.

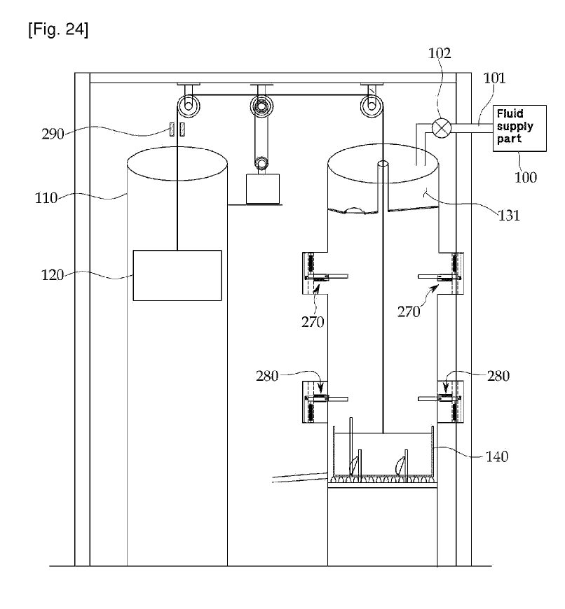

FIG. 24 is a schematic view of a power generation apparatus according to a fifth embodiment of the present invention.

As shown in FIG. 24, in the fifth embodiment of the present invention, the fluid transfer part 211 and the transfer pipe are removed from the second embodiment of the present invention. The power generation apparatus according to the fifth embodiment of the present invention is characterized in that the fluid from the fluid supply part 100 fills in the fluid storage part 131 by a certain amount, and then the movable storage tank 140 rises, and the fluid of the fluid storage part 131 fills into the movable storage tank 140. With the above construction, even when the amount of the fluid from the fluid storage tank 140 is small, since it is first filled into the fluid storage part 131 by a certain amount, and then it filled into the movable storage tank 140, it is possible to generate a high power.

The seesaw motions of the weight load 120 and the movable storage tank 140 and the operations of the supply maintaining unit 270 and the discharge maintaining unit 280 are same as the second embodiment of the present invention, so the detailed descriptions will be omitted.

In the present embodiment, the occasion that there is provided a weight load guide box 110 has been described. Even when the weight load guide box 110 is not present, any construction that a certain amount of the fluid is first filled in the fluid storage part 131 and then the fluid is filled in the movable storage tank 140 might be applied to the present invention.

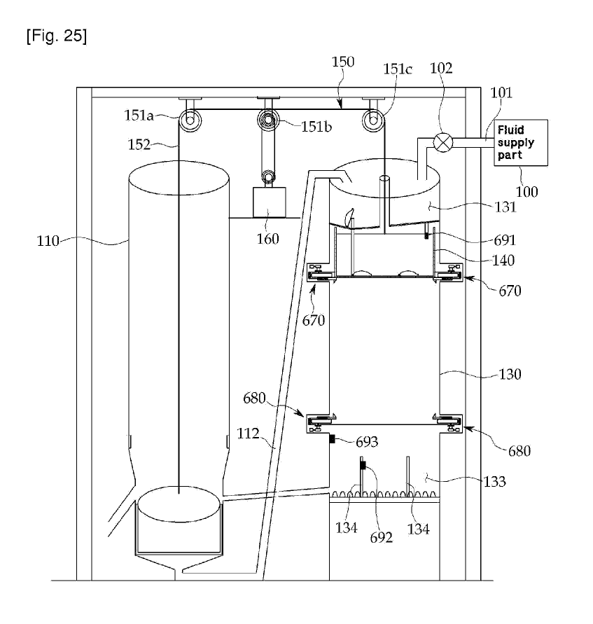

FIGS. 25 to 34 are schematic views of a power generation apparatus according to a sixth embodiment of the present invention.

As shown in FIGS. 25 and 34, the sixth embodiment of the present invention is different from the second embodiment in view that the supply maintaining unit 270 and the discharge maintaining unit 280 operate in accordance with an electric signal.

In the sixth embodiment of the present invention, the supply maintaining unit 670 and the discharge maintaining unit 680 are different from the second embodiment, and the first and second fluid detection sensors 691 and 692, the tank detection sensor 693 and the controller 694 are further provided.

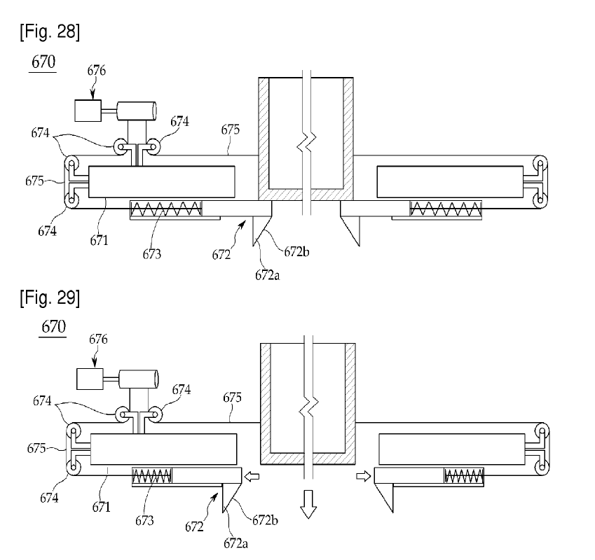

The supply maintaining unit 670 of the sixth embodiment of the present invention, as shown in FIGS. 28 to 30, comprises a supply support member 671, a supply stopper 672, a supply stopper spring 673, a supply pullet 674, a supply wire 675 and a supply driving motor 676.

The supply support member 671 is installed being supported by the movable storage tank guide box 130 for thereby supporting the remaining elements of the supply maintaining unit 670.

The supply stopper 672 is installed at the supply support member 671 while being slidable in a radius direction of the movable storage tank guide box 130 for thereby selectively limiting the down movement of the movable storage tank 140. The supply stopper 672 remains pressurized at the supply stopper spring 673 in the direction of the center of the movable storage tank guide box 130. At an end portion is provided a contact part 672a having an inclined surface 672b so that the supply stopper 672 can be pushed outwardly by means of the movable storage tank 140 when the movable storage tank 140 moves upwards.

The supply pulley 674 is to guide the supply wire 675 and is provided at the supply support member 671 in multiple numbers.

The supply wire 675 is connected with its one end being connected to the supply driving motor 676, the other end being connected to the supply stopper 672. When the supply driving motor 676 is driven in the direction that the supply wire 675 is wound, the supply wire 675 slides the supply stopper 672 toward the outside while overcoming the elastic force of the supply stopper spring 673. The movable storage tank 140, of which the down movement is limited by means of the supply stopper 672, can descend. In the present invention, it is shown like the supply wire 675 is positioned at a portion where it is interred when the movable storage tank 140 moves, but the supply wire 675 is positioned where the movement of the movable storage tank 140 is not interfered with.

The discharge maintaining unit 680 has similar constructions and operations with the supply maintaining unit 670. In more details, as shown in FIGS. 31 to 33, the discharge maintaining unit 680 comprises a discharge support member 681, a discharge stopper 682, a discharge stopper spring 683, a discharge pulley 684, a discharge wire 685 and a discharge driving motor 686.

The discharge support member 681 is disposed at a lower side of the supply support member 671 and is supported by the movable storage tank guide box 130 while supporting the remaining elements of the discharge maintaining unit 680.

The discharge stopper 682 is installed at the discharge support member 681 while being slidable in the radius direction of the movable storage tank guide box 130 for thereby selectively limiting the rising movement of the movable storage tank 140. The discharge stopper 682 remains at the discharge stopper spring 683 while being pressurized in the center direction of the movable storage tank guide box 130. At an end portion of the discharge stopper 682 is provided a contact part 682a having an inclined surface 682b so that the discharge stopper 682 can be pushed outwardly be means of the movable storage tank 140.

The discharge pulley 684 is to guide the discharge wire 685 and is provided at the discharge support member 681 in multiple numbers.

The discharge wire 685 is installed, with its one end being connected with the discharge driving motor 686, with its other end being connected with the discharge stopper 682. When the discharge driving motor 686 is driven in the direction that the discharge wire 685 is wound, the discharge wire 685 slides the discharge stopper 682 in the direction of the outside while overcoming the elastic force of the discharge stopper spring 683. So, the movable storage tank 140 of which the upward movement is limited by means of the discharge stopper 682 can rise. In the present embodiment, the movable storage tank 140 is positioned as being interfered with when the movable storage tank 140 moves, but the discharge wire 685 is positioned while not being interfered with the movement of the movable storage tank 140.

The first fluid detection sensor 691 is to detect whether or not the fluid of the fluid storage part 131 is filled in the movable storage tank 140 by a certain level. As shown in FIGS. 25 to 27, it is installed below the fluid storage part 131. In more particular, the first fluid detection sensor 691 outputs an ON signal to the controller 694 when the fluid is filled in the movable storage tank 140 by a certain amount. So the controller 694 drives the supply driving motor 676 and moves the supply stopper 672 to the outside. So, the movable storage tank 676 starts moving downwards.

The second fluid detection sensor 692 is to detect whether or not the movable storage tank 140 has discharged all the fluid from the fluid discharge part 133 and is disposed at the retrieval opening member 134 of the fluid discharge part 133. When all the fluid is discharged with the movable storage tank 140 being close to the fluid discharge part 133, the second fluid detection sensor 692 does not sense the fluid, so an OFF signal is transmitted to the controller 694. The controller 694 judges as all the fluid has been discharged from the movable storage tank 140, and drives the discharge driving motor 686 for thereby moving the discharge stopper 682 to the outside, so that the movable storage tank 140 can move upwards.

The tank detection sensor 693 is to control the driving timing of the discharge driving motor 686 along with the second fluid detection sensor 692. In more particular, when the movable storage tank 140 is detected by the tank detection sensor 693, the tank detection sensor 693 judges as the movable storage tank 140 is close to the fluid discharge part 133 for thereby controlling the discharge driving motor 686 depending on the information from the second fluid detection sensor 692. However, when the tank detection sensor 693 outputs an OFF signal, which means that the movable storage tank 140 is not detected, to the controller 694, the controller 694 judges as the movable storage tank 140 has not reached the fluid discharge part 133, so it does not allow the discharge driving motor 686 to operate even when the OFF signal is outputted from the second fluid detection sensor 692. The tank detection sensor 693 may be formed of various known sensors such as a proximity sensor or something.

The controller 694 is to control whether the driving motors 676 and 686 are driven or not in response to the signals from the first and second fluid detection sensors 691 and 692 and the signals from the tank detection sensor 693. The functions of the controller 694 will be described in details.

The operation of the power generation apparatus according to the sixth embodiment of the present invention will be described.

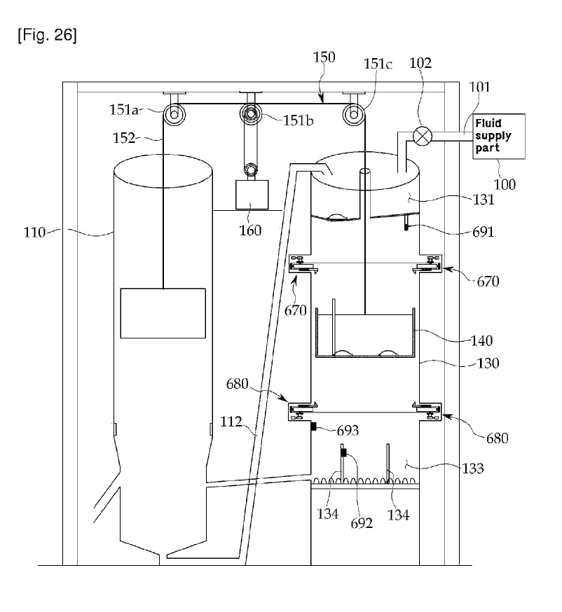

FIG. 25 is a view showing a state that the movable storage tank 140 is close to the fluid storage part 131. In the above state, as shown in FIG. 28, the movable storage tank 140 is supported by the supply stopper 672 and does not move downwards even when it becomes heavier than the weight load 120. When the first fluid detection sensor 691 senses when the fluid is filled from the fluid storage part 131 to the movable storage tank 140 by a certain amount, the first detection sensor 691 outputs an ON signal to the controller 694. The controller 694 drives the supply driven motor 676. So, the supply driving motor 676 winds and pulls the supply wire 675, and then the supply stopper 672 retracts to the outside. As shown in FIG. 29, the movable storage tank 140 becomes movable downward and then starts moving downwards by means of the self-weight as shown in FIG. 26.

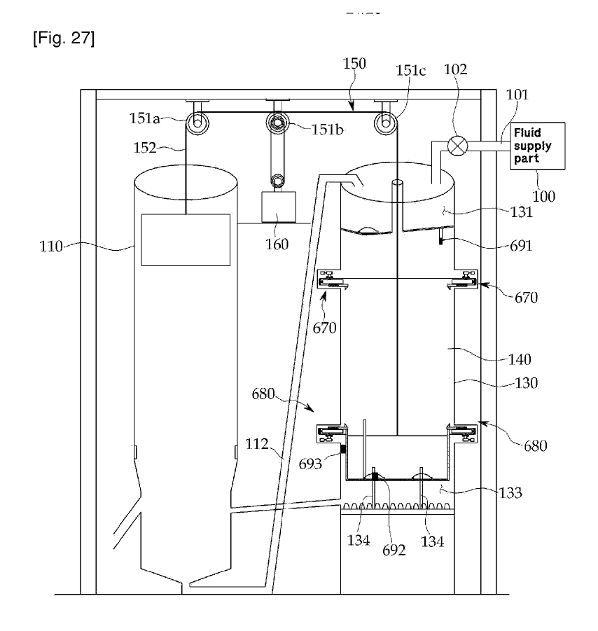

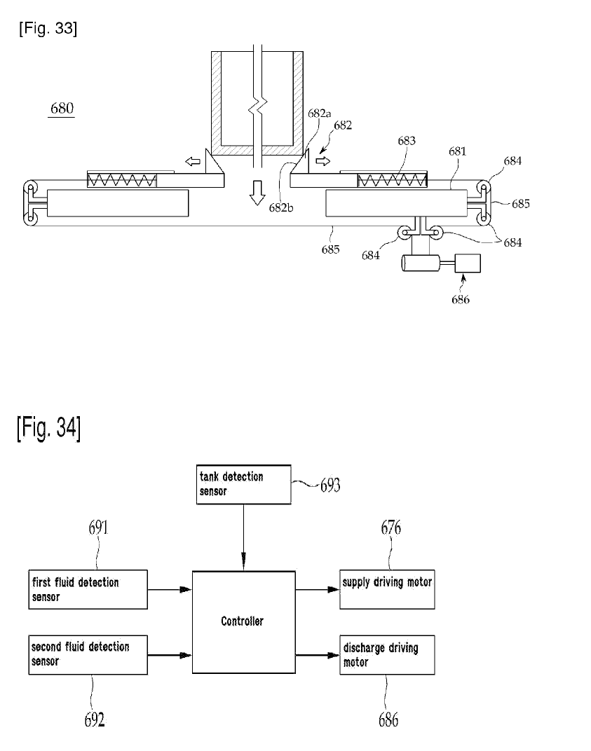

When the movable storage tank 140 keeps moving downwards and then reaches the discharge maintaining unit 680, as shown in FIG. 33, the bottom of the movable storage tank 140 comes into contact with the inclined surface 682b of the discharge stopper 682, and the discharge stopper 682 is retracted toward the outside. As shown in FIG. 27, the movable storage tank 140 reaches the fluid discharge part 133. When it reaches the fluid discharge part 133, the fluid of the movable storage tank 140 is discharged toward the fluid discharge part 133 with the aid of the retrieval opening and closing member 134. At this time, the tank detection sensor 693 detects the movable storage tank 140 and outputs an ON signal to the controller 694. Here, the controller 694 controls the driving motor 686 in accordance with a signal from the fluid detection sensor 692. When the fluid is discharged from the movable storage tank 140, and the movable storage tank 140 becomes lighter than the weight load 120, the movable storage tank 140 starts moving towards. As shown in FIG. 31, the rising operation of the movable storage tank 140 is limited by means of the discharge stopper 682. When all the fluid of the movable storage tank 140 is discharged, the second detection sensor 692 outputs an OFF signal to the controller 694. The controller 694 drives the discharge driving motor 686 and winds the discharge wire 685. As shown in FIG. 32, the discharge stopper 682 retracts to the outside, so the movable storage tank 140 moves upwards.

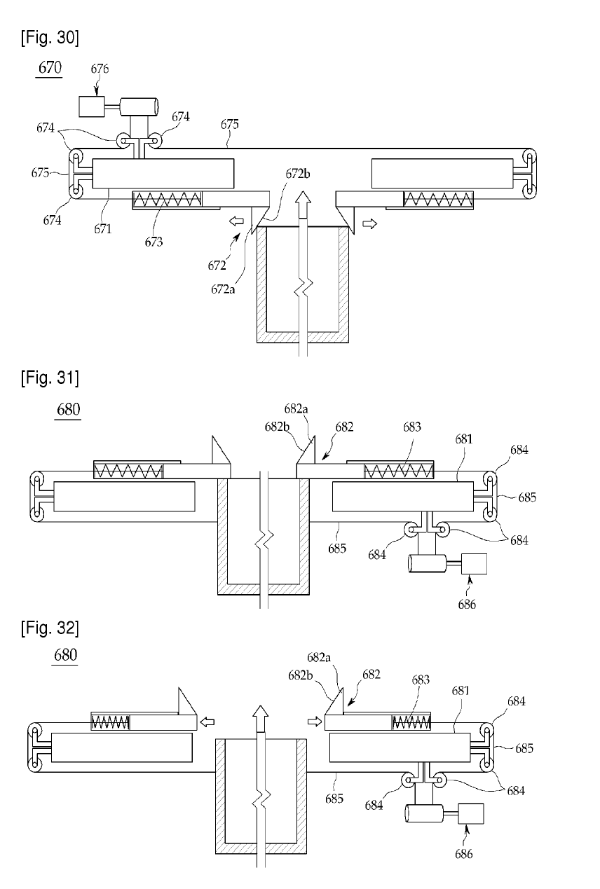

When the movable storage tank 140 moves upwards and then reaches the supply maintaining unit, as shown in FIG. 30, it pushes the inclined surface 672b of the supply stopper 672 and retracts the supply stopper 672 to the outside and moves toward the fluid storage part 131.

The up and down movements of the movable storage tank 140 is repeatedly performed, which results in generating power like electric power.

FIGS. 35 to 38 are schematic views illustrating a power generation apparatus according to a seventh embodiment of the present invention.

As shown in FIG. 35, in the seventh embodiment of the present invention, the power generation apparatus is improved to a power generation apparatus which can be efficiently applied to where waves are naturally produced like at sea or river. In the present invention, the occasion that the power generation apparatus of the present invention is installed at sea will be described.

In the seventh embodiment of the present invention, as shown in FIG. 35, there is provided an inlet part 732 so sea water can be inputted into the fluid storage part 131. The inlet part 732 comprises an inlet port 732a formed at the fluid storage part 131 and an opening and closing door 732b for selectively blocking the inlet port 732a with the aid of the buoyancy of the sea water.

As shown in FIG. 36, the opening and closing door 732b is placed at a lower place with the aid of its self-weight when the amount of seawater inputted into the fluid storage part 131 is small. So, the inlet port 732a of the fluid storage part 131 remains open, and the seawater can flow into the fluid storage part 131 via the inlet port 732a. When the seawater is inputted into the fluid storage part 131 and the level of the water rises, as shown in FIG. 37, the opening and closing door 732b rises by means of the buoyancy of the seawater, and the opening and closing door 732b gradually closes the inlet port 372a. When a certain amount of the seawater is filled in the fluid storage part 131, as shown in FIG. 38, the opening and closing door 732b fully blocks the inlet port 732a, so the seawater no longer inputs into the fluid storage part 131. Differently from the above embodiment of the present invention, the inlet port 732a may be formed with the upper side of the fluid storage part 131 being open. The inlet port may be formed in various method and forms as long as seawater can input into the fluid storage part 131 with the aid of water waves.

As shown in FIG. 35, at the bottom of the fluid discharge part 133 are provided a water level detection sensor 735 and a pump 736. So, the fluid discharged from the movable storage tank 140 to the fluid discharge part 133 forcibly falls down via the discharge hole 133a. When a certain amount of fluid is filled into the forced discharge part 734, the water level detection sensor 735 outputs an ON signal to the pump 736. So, the pump 736 starts driving, and the fluid is sucked from the forced discharge part 734 and is discharged to the outside. The pump 736 keeps operating until an OFF signal is outputted from the water level detection sensor 735. When the pump 736 stops driving, the flow path is blocked by means of the check valve 737, and the seawater is prevented from inputting into the forced discharge part 734.

In the present invention, it is possible to generate power by efficiently using seawater wave energy in such a manner that the seawater is inputted into the fluid storage part 131 by using the waves of seawater, and the movable storage tank 140 is moved downwards by using the inputted seawater.

In the present embodiment of the present invention, the example that the forced discharge part 734 is arranged at the lower side of the movable storage tank guide box 130 has been described, but the forced discharge part 734 might be arranged at the weight load guide box 110 differently from the present embodiment. In this case, a retrieval pipe by which the fluid of the fluid discharge part 133 can be retrieved into the weight load guide box 110 can be installed like in the first embodiment of the present invention.

In the present embodiment of the present invention, the weight load guide box 110 may be made in a sealed structure which makes it possible to prevent the seawater from inputting into the interior. The movable storage tank guide box 130 may be formed in a sealed structure as well except for the inlet part 732. The supply maintaining unit 670 and the discharge maintaining unit 680 might be installed at the movable storage tank guide box 130 in a sealed structure.

Since the up and down movements of the movable storage tank 140 and the operations of the supply maintaining unit 670 and the discharge maintaining unit 680 of the power generation apparatus are the same as the sixth embodiment of the present invention, so the detailed descriptions will be omitted.

In the present embodiment of the present invention, the occasion that it is installed where water waves are naturally produced like at sea or river is installed, but the power generation apparatus of the present invention might be installed under water where does not have waves.

FIG. 39 is a schematic view illustrating a power generation apparatus according to an eighth embodiment of the present invention.

As shown in FIG. 39, in the power generation apparatus according to an eighth embodiment of the present invention, the fluid inputted from the movable storage tank 140 into the fluid discharge part 133 is transferred to the fluid storage part 211 via the retrieval pipe 135. The fluid transferred to the fluid storage part 211 is discharged to the outside of the weight load guide box 110 with the aid of the contractible member 712. Here, at the discharge pipe 712a of the contractible member 712 is installed a check valve 712b.

With the above construction, the weight load moves downwards and pressurizes the contractible member 712, so the contractible member 712 is contracted, and the fluid of the contractible member 712 is discharged via the discharge pipe 712a. When the weight load 120 moves upwards again, the contractible member 712 is elongated for the fluid of the fluid transfer part 211 to be sucked into the interior of the contractible member 712. Since the principle for sucking the fluid into the contractible member 712 is the same as the second embodiment of the present invention, the detailed descriptions of the same will be omitted. When sucking the fluid into the interior of the contractible member 712, the check valve 712b blocks the discharge pipe 712 for thereby preventing external seawater from inputting into the interior of the contractible member 712.

In the present embodiment of the present invention, the occasion that the check valve 712b is applied, but it can be selected among various known check valves and then can be applied to the discharge pipe 712b.

FIG. 40 is a schematic view illustrating a power generation apparatus according to a ninth embodiment of the present invention.

According to the ninth embodiment of the present invention, the fluid supply part 100 for supplying external fluid is omitted. Namely, the fluid pressurized by means of the weight load 120 is gathered into the fluid storage par 131 via the transfer pipe, and the fluid gathered at the fluid storage part 131 by a certain amount is supplied to the movable storage tank 140, so the movable storage tank 140 can move downwards. The movable storage tank 140 discharges the fluid via the fluid discharge part 133 and transfers the fluid to the fluid transfer part 111 via the retrieval pipe 135 for thereby allowing the movable storage tank 140 to move upwards.

With the above advantageous constructions, it is possible to simplify the constructions of the power generation apparatus. The remaining constructions and operations are the same as the first embodiment of the present invention, the detailed descriptions of the same will be omitted.

### INDUSTRIAL APPLICABILITY

The power generation apparatus according to the present invention can be well applied to generating power by using water at an apartment building or a high rise place or various places. In addition, the power generation apparatus of the present invention can be applied to an underwater place and can be applied to generating power even at sea or river where water waves or swell are made.

1. A power generation apparatus, comprising:
a weight load which is movable upwards and downwards;
a movable storage tank guide box which includes a storage part at its upper side for collecting fluid from a fluid supply part, a fluid discharge part provided at its lower side, and a supply opening and closing part for selectively discharging the fluid gathered at the fluid storage part;
a movable storage part which is accommodated at the movable storage tank guide box and is movable upward and downwards between the fluid storage part and the fluid discharge part and includes a retrieval opening and closing part for selectively discharging the fluid collected via the supply opening and closing part at a portion close to the fluid storage part to the fluid discharge part at a portion close to the fluid discharge part; and
a power transfer unit which connects the movable storage tank and the weight load in a way of transferring power and moves the movable storage tank downwards when the weight load moves upwards, and moves the movable storage tank upwards when the weight load moves downwards.

2. A power generation apparatus according to claim 1, further comprising:
a weight load guide box in which the weight load is accommodated and is movable upwards and downwards; and
a fluid transfer part which is provided at a lower side of either the weight load guide box or the movable storage tank guide box and is connected with the fluid discharge part in a way that fluid can flow and pressurizes the fluid inputted from the fluid discharge part with the aid of either the weight load or the self-weight of the movable storage tank and transfers the pressurized fluid to the fluid storage part via the transfer pipe.

3. A power generation apparatus according to claim 2, wherein said fluid transfer part is provided at a lower side of the weight load guide box and communicates with the fluid discharge part via the retrieval pipe so that the fluid of the fluid transfer part is pressurized by means of the self-weight of the weight load, and the fluid of the fluid discharge part can be inputted.

4. A power generation apparatus according to claim 3, further comprising:
a supply opening and closing member which is provided at the movable storage tank so that the movable storage tank can allow the supply opening and closing part to open at a portion close to the fluid storage part; and
a retrieval opening member which is provided at the fluid discharge part so that the movable storage tank can allow the retrieval opening and closing member to open at a portion close to the fluid discharge part.

5. A power generation apparatus according to claim 4, wherein said supply opening and closing part comprises:
a supply hole formed at the bottom of the fluid storage part; and
a supply opening and closing part which is rotatably installed at the bottom of the fluid storage part for closing the supply hole with the aid of self-weight and rotates upwards with the aid of the supply opening member and allows the supply hole to open, and
said retrieval opening and closing part comprises:
a retrieval hole formed at the bottom of the movable storage tank; and
a retrieval opening member which is rotatably installed at the bottom of the movable storage tank for closing the retrieval hole with the aid of self-weight and rotates upwards with the aid of the retrieval opening member and allows the retrieval hole to open.

6. A power generation apparatus according to claim 3, wherein said fluid transfer part comprises:
a contractible member which includes an opening for inputting the fluid supplied from the retrieval pipe into the interior and becomes contractible by means of the weight load and transfers the fluid inputted into the interior via the opening to the fluid storage part via the transfer pipe; and
a blocking member which is rotatably installed at the contractible member for selectively opening and closing the opening and moves depending on the movement of the weight load for thereby selectively opening and closing the opening.

7. A power generation apparatus according to claim 1, further comprising:
a supply maintaining unit which limits the downward movements of the movable storage tank for the same to be maintained at a portion close to the fluid storing part until fluid is inputted from the fluid storage part into the movable storage tank by above a certain reference amount and releases the downward movement limit of the movable storage tank when the fluid is applied to the movable storage tank by above a certain reference amount; and
a discharge maintaining unit which limits the upward movements of the movable storage tank for the fluid to keep discharging until fluid becomes below a certain reference level at a portion close to the fluid discharge part and releases the upward movement limit of the movable storage tank when the fluid of the movable storage tank becomes below a certain reference level.

8. A power generation apparatus according to claim 7, wherein said supply maintaining unit comprises:
a supply slide member which is slidable in upward and downward directions in the interior of the movable storage tank guide box;
a supply slide spring which applies a tensional force for pulling the supply slide member upwards;
a supply rotation member which is rotatably installed in upward and downward directions at an end portion of the supply slide member;
a supply stopper which is slidable at the supply slide member in a radius direction of the movable storage tank guide box and selectively limits the operation that the supply rotation member rotates downwards;
a supply stopper spring which pressurizes the supply stopper in a direction of the center of the movable storage tank guide box;
a supply pullet which is provided at the other end portion of the supply slide member 271; and
a supply wire of which one end is connected with the movable storage tank guide box, and the other end is fixed at the supply stopper 274 for thereby releasing the downward rotation limit of the supply rotation member by moving the supply stopper toward an outer surface of the movable storage tank guide box when the supply slide member moves downwards; and
said discharge maintaining unit comprises:
a discharge slide member which is slidable in upward and downward directions in the interior of the movable storage tank guide box;
a discharge slide spring which applies a tensional force to the discharge slide member so that the discharge slide member can be pulled upwards and pressurizes the slide member downwards when the discharge slide member moves upwards;
a discharge rotation member which is rotatable in upward and downward directions at an end portion of the discharge slide member;
a rotation return elastic member which returns the discharge rotation member to an original position in a state that the discharge rotation member has moved downwards;
a discharge stopper which limits the discharge rotation member to rotate upwards;
a discharge stopper spring which pressurizes the discharge stopper in the direction of the center of the movable storage tank guide box;
a discharge pulley which is provided at the other end portion of the discharge slide member; and
a discharge wire of which one end is fixed at the movable storage guide box in a way of surrounding part of the discharge slide member, and the other end portion is fixed at the discharge stopper for thereby obtaining an upward rotation of the discharge rotation member by moving the discharge stopper in an outer surface direction of the movable storage tank guide box when the discharge slide member moves upwards while overcoming the elastic force of the discharge slide spring.

9. A power generation apparatus according to claim 3, wherein said power transfer unit comprises:
at least one pulley; and
a power transfer wire which surrounds at least part of the pulley and of which one end portion is fixed at the weight load, and the other end portion is fixed at the movable storage tank.

10. A power generation apparatus according to claim 3, wherein said power transfer unit comprises:
a first rack gear of which one end portion is fixed at the weight load;
a second rack gear of which one end portion is fixed at the movable storage tank; and
a plurality of power transfer gears which are engaged with the first and second rack gears, respectively, so that the weight load moves upwards when the movable storage tank moves downwards, and the weight load moves downwards when the movable storage tank moves upwards.

11. A power generation apparatus according to claim 10, further comprising:
a retrieval pipe opening and closing unit which is installed at a lower portion of the movable storage tank guide box and operates depending on the movement of the movable storage tank and selectively opens and closes the retrieval pipe.

12. A power generation apparatus according to claim 11, wherein said retrieval pipe opening and closing unit comprises:
an opening and closing member which is movable in upward and downward directions in the interior of the movable storage tank guide box and operates depending on the upward and downward movements of the movable storage tank and selectively blocks the retrieval pipe; and
an elastic member which is provided at the opening and closing member and applies an elastic force in the direction that the retrieval pipe can open.

13. A power generation apparatus according to claim 12, further comprising:
a buoyancy member which is provided at the bottom of the movable storage tank and moves upwards with the aid of the fluid gathered at the fluid discharge part as the retrieval pipe is blocked by means of the opening and closing member.

14. A power generation apparatus according to claim 3, wherein a spacer is provided at the bottom of the movable storage tank for allowing the fluid of the movable storage tank to input into the retrieval pipe via the retrieval opening and closing part by maintaining a certain space between the bottom of the movable storage tank and the bottom of the fluid discharge part.

15. A power generation apparatus according to claim 1, further comprising:
a fluid transfer part which communicates with the fluid storage part via the transfer pipe and is provided at a lower side of the movable storage tank guide box and is connected with the fluid discharge part in a way of fluid transfer, wherein the fluid inputted from the fluid discharge part into the fluid transfer part is pressurized by means of the self-weight of the movable storage tank and is transferred to the fluid storage part via the transfer pipe.

16. A power generation apparatus according to claim 1, further comprising:
a supply maintaining unit which limits the downward movement of the movable storage tank for the same to be positioned at a portion close to the fluid storage part until the fluid is supplied from the fluid storage part to the movable storage tank by above a certain reference amount and releases the downward movement limit of the movable storage tank when the fluid is supplied to the movable storage tank by above a certain reference amount;
a discharge maintain unit which limits the upward movement of the movable storage tank for the fluid to keep discharging until the fluid of the movable storage tank becomes below a certain reference level at a portion close to the fluid discharge part, and releases the upward movement limit of the movable storage tank when the fluid of the movable storage tank becomes below a certain reference amount;
a first fluid detection sensor which is downwardly protruded from the fluid storage part for thereby detecting the water level of the fluid filled in the movable storage tank;
a second fluid detection sensor which is provided at the fluid discharge part for thereby detecting the water level of the fluid remaining in the movable storage tank; and
a controller which controls the supply maintaining unit so that the downward movement of the movable storage tank is possible when the water level of the movable storage tank detected by the first fluid detection sensor is above a certain reference level, and controls the discharge maintaining unit so that the upward movement of the movable storage tank is possible when the water level of the movable storage tank detected by the second fluid detection sensor is below a certain reference value.

17. A power generation apparatus according to claim 1, wherein said fluid supply part is water in which the power generation apparatus is partially submerged, and an inlet part is provided at the fluid storage part for inputting said water.

18. A power generation apparatus according to claim 17, wherein said inlet part comprises:
an inlet port provided at the fluid storage part for inputting water; and
an opening and closing door for selectively opening and closing the inlet port depending on the amount of the water inputted into the fluid storage part.

19. A power generation apparatus according to claim 17, further comprising:
a forced discharge part for collecting the fluid inputted from the movable storage tank to the fluid discharge part;
a water level detection sensor for detecting the water level of the forced discharge part;
a pump for transferring the fluid of the forced discharge part to the outside when the water level of the forced discharge part detected by the water level detection sensor exceeds a certain reference value; and
a check valve for preventing the water from reversely inputting into the forced discharge part.

20. A power generation apparatus, comprising:
a weight load guide box;
a weight load which is accommodated in the weight load guide box and is movable in upward and downward directions;
a movable storage tank guide box which includes a fluid storage part at its upper side, a supply opening and closing part formed at the bottom of the fluid storage part for selectively discharging the fluid gathered at the fluid storage part, and a fluid discharge part formed at its lower side;
a movable storage tank which is accommodated in the movable storage tank guide box so that it can reciprocate in upward and downward directions between the fluid storage part and the fluid discharge part, and includes a retrieval opening and closing part for selectively discharging the fluid gathered via the supply opening and closing part at a portion close to the fluid storage part toward the fluid discharge part at a portion close to the fluid discharge part;
a power transfer unit which connects the movable storage tank and the weight load in a way of transferring power and moves the movable storage tank downwards when the weight load moves upwards, and moves the movable storage tank upwards when the weight load moves downwards; and
a fluid transfer part which is provided at a lower side of the weight load guide box and communicates with the fluid storage part via the transfer pipe and communicates with the fluid discharge part via the retrieval pipe, wherein said fluid transfer part pressurizes the fluid inputted from the fluid discharge part via the retrieval pipe with the aid of the self-weight of the weight load and supplies to the fluid storage part via the transfer pipe.
